(19) United States
(12) Patent Application Publication
(10) Pub. No.: US 2012/0109717 A1
(43) Pub. Date: May 3, 2012

(54) SYSTEM AND METHOD FOR BUSINESS DECISION-MAKING

(76) Inventors: Lin Ma, Graceville (AU); Yong Sun, Durack (AU)

(21) Appl. No.: 13/319,037

(22) PCT Filed: Nov. 3, 2010
(86) PCT No.: PCT/AU10/01465

§ 371 Date: Nov. 4, 2011

(51) Int. Cl. G06Q 10/06

(52) U.S. Cl. 705/7.36

(57) ABSTRACT

Methods, apparatuses and computer program products for supporting of decisions regarding activities of an organisation are disclosed. At least one business objective for activities of the organisation is determined (110) as a control parameter for at least one control tree. At least one constraint affecting the control parameter for at least one constraint tree is determined (112). In a database of computer system, at least one control tree and at least one constraint tree are developed (114) related to the control tree having control and constraint parameters. Relationships amongst constraints and the relationship between the control parameter and constraints are identified (116), and information about relationships is stored (116) in the database. Business activities are evaluated (118) using the control parameter dependent upon identified relationships and constraints. The evaluation result is compared (120) with a predefined value of control parameter for the business objective. A decision is delivered (122) when the business objective is satisfied.

### REFERENCE TO RELATED PATENT APPLICATION

This patent application claims the benefit of the earlier filing date of Australian Provisional Patent Application No. 2009905439, filed 06 Nov. 2009, incorporated by reference in its entirety as if fully set forth herein.

### TECHNICAL FIELD

The invention relates generally to systems and methods for business decision-making and more particularly to optimised multiple-objective business decision making.

### BACKGROUND

Existing approaches/models of decision making for an organisation include Business Process Mapping or Modelling (BPM), Theory Of Constraints (TOC), and Multiple Criteria Decision Making (MCDM). Numerous models and methodologies, such as Evidential Reasoning Approach and Goal Programming, have been developed to implement these approaches.

Business Process Mapping or Modelling (BPM) is a type of technique to document business processes using graphic notations. A business process is a collection of interrelated tasks (activities), which solve a particular issue (see http://en.wikipedia.org/wiki/Business_process).

Theory Of Constraints (TOC) is an overall management philosophy that aims to continually achieve more of the goal of a system (see http://en.wikipedia.org/wiki/Theory_of_constraints). TOC assumes that any organization has one key constraint (often called a bottleneck), which limits the organization from achieving its goal. Therefore, the business performance can be improved by removing this key constraint. The major steps in implementing the TOC approach include:
1) Define the goal.
2) Identify the key constraint that prevents the organization from optimizing the goal.
3) Remove the constraint.
4) Identify a new key constraint and repeat Steps 2) and 3).

TOC has provided five thinking processes:
1) Current reality tree—a graphic description of a sequence of causes and effects from an underlying core problem to its symptoms, which often arise from a conflict.
2) Evaporating cloud—a method to assist in finding a “win-win” solution to a conflict between two parties.
3) Future reality tree—a graphic description of future states of the system after an action so that possible negative outcomes can be identified.
4) Prerequisite tree—a graphic statement of the required intermediate objectives for conducting an action and obstacles that need to be overcome in the course of the action.
5) Transition tree—a detailed description of the action that leads to the implementation of changes.
6) Strategy and tactics tree—the overall plan and metrics that leads to a successful implementation of changes and ongoing improvement (see http://en.wikipedia.org/wiki/Theory_of_constraints).

Multiple Criteria Decision Making (MCDM) is a group of methods used for making decisions with multiple criteria and that aim to finding the optimal solution when a number of criteria (often these criteria conflict to each other) exist.

Disadvantageously, BPM focuses on documentation and representation of business activities and the sequence of these activities, the TOC focuses on identification of key constraint and strategy to eliminate the constraint, and the MCDM focuses on finding the optimal decision when there are multiple conflict criteria.

### SUMMARY

In accordance with an aspect of the invention, there is provided a computer-implemented method of supporting of decisions considering business objectives and constraints of an organisation. At least one business objective for activities of the organisation is determined as a control parameter for at least one control tree. At least one constraint affecting the control parameter for at least one constraint tree is determined. In a database of a computer system, at least one control tree and at least one constraint tree are developed related to the control tree having control and constraint parameters. The control tree comprises information about sub-objectives associated with the business objective. The constraint tree comprises information about a factor limiting the activities of the organisation to achieve the business objective. Each tree comprises blocks that record and represent factors associated with the business activities of the organisation. The blocks of each tree have a relational connection between a parent block and at least one child block in the tree including at least one logic operator. The relationships amongst constraints and the relationship between the control parameter and the constraints are identified, and information about the relationships is stored in the database. The business activities of the organisation are evaluated using the control parameter dependent upon the identified relationships and the constraints. The result of the evaluation is compared with a predefined value of the control parameter for the business objective using a computer system coupled to the database. A decision is delivered when the business objective is satisfied.

In accordance with a further aspect of the invention, there is provided an apparatus for supporting of decisions considering business objectives and constraints of an organisation. The apparatus comprises: a module for determining at least one business objective for activities of the organisation as a control parameter for at least one control tree; a module for determining at least one constraint affecting the control parameter for at least one constraint tree; a module for developing in a database of a computer system at least one control tree and at least one constraint tree related to the control tree having control and constraint parameters, the control tree comprising information about a plurality of sub-objectives associated with the business objective, the constraint tree comprising information about a factor limiting the activities of the organisation to achieve the business objective, each tree comprising a plurality of blocks that record and represent factors associated with the business activities of the organisation, the blocks of each tree having a relational connection between a parent block and at least one child block in the tree including at least one logic operator; a module for identifying the relationships amongst constraints and the relationship between the control parameter and the constraints and storing information about the relationships in the database; a module for evaluating the business activities of the organisation using the control parameter dependent upon the identified relationships and the constraints; a module for comparing the result of the evaluation with a predefined value of the control parameter for the business objective using a computer system coupled to the database; and a module for delivering a decision when the business objective is satisfied.

In accordance with yet another aspect of the invention, there is provided an apparatus for supporting of decisions considering business objectives and constraints of an organisation. The apparatus comprises a storage device storing a database, a memory for storing data, a portion of the database obtained from the storage device, and a computer program, and a professing unit coupled to the memory for executing the computer program. The computer program comprises: a computer program code module for determining at least one business objective for activities of the organisation as a control parameter for at least one control tree; a computer program code module for determining at least one constraint affecting the control parameter for at least one constraint tree; a computer program code module for developing in the database at least one control tree and at least one constraint tree related to the control tree having control and constraint parameters, the control tree comprising information about a plurality of sub-objectives associated with the business objective, the constraint tree comprising information about a factor limiting the activities of the organisation to achieve the business objective, each tree comprising a plurality of blocks that record and represent factors associated with the business activities of the organisation, the blocks of each tree having a relational connection between a parent block and at least one child block in the tree including at least one logic operator; a computer program code module for identifying the relationships amongst constraints and the relationship between the control parameter and the constraints and storing information about the relationships in the database; a computer program code module for evaluating the business activities of the organisation using the control parameter dependent upon the identified relationships and the constraints; a computer program code module for comparing the result of the evaluation with a predefined value of the control parameter for the business objective; and a computer program code module for delivering a decision when the business objective is satisfied.

In accordance with still another aspect of the invention, there is provided a computer program product comprising a computer readable medium have recorded thereon a computer program for semi-automated supporting of decisions considering business objectives and constraints of an organisation for execution on a processing unit. The computer program comprises: a computer program code module for determining at least one business objective for activities of the organisation as a control parameter for at least one control tree; a computer program code module for determining at least one constraint affecting the control parameter for at least one constraint tree; a computer program code module for developing in the database at least one control tree and at least one constraint tree related to the control tree having control and constraint parameters, the control tree comprising information about a plurality of sub-objectives associated with the business objective, the constraint tree comprising information about a factor limiting the activities of the organisation to achieve the business objective, each tree comprising a plurality of blocks that record and represent factors associated with the business activities of the organisation, the blocks of each tree having a relational connection between a parent block and at leak one child block in the tree including at least one logic operator; a computer program code module for identifying the relationships amongst constraints and the relationship between the control parameter and the constraints and storing information about the relationships in the database; a computer program code module for evaluating the business activities of the organisation using the control parameter dependent upon the identified relationships and the constraints; a computer program code module for comparing the result of the evaluation with a predefined value of the control parameter for the business objective; and a computer program code module for delivering a decision when the business objective is satisfied.

### BRIEF DESCRIPTION OF DRAWINGS

The embodiments of the invention are described hereinafter with reference to the drawings, in which:

FIG. 1 is a flow diagram of a computer-implemented method of automated making of decisions regarding a business objective of an organisation in accordance with an embodiment of the invention;

FIG. 2 is a detailed flow diagram of a method for making a business decision dependent upon control and constraint trees in accordance with an embodiment of the invention;

FIG. 3A is a relationship diagram illustrating an example of a particular control tree (Financial Control) demonstrating a top event decomposed into a number of basic events for a control parameter;

FIG. 3B lists all legends for using in FIGS. 3A and 4; and

FIG. 4 is a relationship diagram illustrating an example of a particular constraint tree (Capacity of Assets) demonstrating a top event decomposed into a number of basic events for a control parameter;

FIG. 5 is a diagram illustrating the identification of business objectives;

FIG. 6 is a relationship diagram illustrating the identification of a control parameter;

FIG. 7 is a relationship diagram illustrating the identification of critical constraints;

FIG. 8 is a relationship diagram illustrating the identification of the linkage between a control parameter and a critical constraint;

FIG. 9 illustrates two plots showing the identification of the relationship between the control parameter and the critical constraint;

FIG. 10 is a plot showing predicted expenditure of a given asset;

FIG. 11 is a plot showing a budget plan for a given group of assets; and

FIG. 12 is a block diagram of a general-purpose computer with embodiments of the invention may be practiced.

### DETAILED DESCRIPTION

Methods, apparatuses, and computer program products for automated making of decisions regarding a business objective of an organisation are disclosed. In the following description, numerous specific details, including particular business objectives/goals, control parameters and constraints, specific logic operators, data structures including tree structures, and the like are set forth. However, from this disclosure, it will be apparent to those skilled in the art that modifications and/or substitutions may be made without departing from the scope and spirit of the invention. In other circumstances, specific details may be omitted so as not to obscure the invention.

Where reference is made in any one or more of the accompanying drawings to steps and/or features, which have the same reference numerals, those steps and/or features have for the purposes of this description the same function(s) or operation(s), unless the contrary intention appears.

The embodiments of the invention are directed to optimal-decision making for various activities of a business process within an organisation by modelling the multi-dimensional, dynamic relationships of organisational goals and business constraints. A common component that is missing in the existing models noted above is a quantitative analysis of the dynamic relationship of business activities of an organization, its objectives, and the constraints. Another aspect missing in such existing models is a systematic methodology to identify multiple constraints, so that decision model can be formulated. The embodiments of the invention have been designed for this purpose, so that an organisation can formulate, even make, an optimal decision for its activities based on a comprehensive and quantitative evaluation of the complex relationships between business objectives/goals and constraints. The embodiments of the invention may be implemented as a computer program, for example, in which a software tool uses multiple templates for both Control and Constraint trees (CCT), as described hereinafter. The templates have interrelationships with each other. The parameters in different trees can be related to and restrained by each other. The software tool can also include multiple graphical user interfaces (GUI) and a database. Graphical user interfaces are used to display these trees and relationship charts. The database is used to store these trees and relationship charts, as well as the corresponding attributes such as blocks and parameters. The CCT technology is a technique that can assist to formulate complex relationships of multiple factors in a decision model.

The Control and Constraint Trees approach has two important elements:
Control Tree; and
Constraint Tree.
   A Control Tree identifies all sub-goals at different levels of the business activities in an organisation and builds a linkage between these goals. These sub-goals are directly derived from the core goal that the organisation wants to optimise. A Constraint Tree identifies critical factors that limit the ability of the organisation to optimise its core goal and links major factors at different levels for determining optimal decision parameters to a constraint, which either is derived from one of the overall objectives of an organisation or comes from an external requirement. These two types of trees use the same structuring techniques, but have different functionalities. The trees themselves each comprise the following components:
Blocks
   The blocks are the basic elements in the Control Trees and Constraint Trees. A block is used to record and represent a factor that is associated with the business of an organisation.
   Blocks include Top Blocks, Intermediate Blocks, and Basic Blocks according to their locations in the trees. Top Blocks, Intermediate Blocks and Basic Blocks are defined relatively to a specific tree. Their roles can be exchanged in different trees, e.g., a Top Block in one tree can be a Basic Block in another tree.
Top Blocks
   These blocks sit on the top of the trees. The trees start from these blocks. They do not have any parent block.
Intermediate Blocks
   These blocks are located in the middle of the trees, are derived from other blocks, and also have offspring blocks.
Basic Blocks
   These blocks are on the bottom of the trees. They do not have any child blocks.
Relational connections
   These are the lines plus logical operators in the trees. A typical relational connection is a logical operator associated with several lines, which are used to connect a number of blocks. The relational connection is used to identify a parent block and its child blocks, as well as the logical relationship between the parent block and the child blocks.
Logic operators
   Logic operators include “Inclusive OR”, “Exclusive OR”, and “AND”, all of which are well known to those skilled in the art.
   Other logical operators include:
      Voting OR: A parent event occurs if a given number or more of its child events occur;
      Inhibit: A parent event occurs if all its child events occur and a conditional event occurs; and
      Priority AND—A parent event occurs if all its child events occur in a specific sequence.

Both control trees and constraint trees start from top blocks. Both top blocks and intermediate blocks have children blocks but the basic blocks do not have. The connections and the operators link all blocks together and indicate the logic relationships between a block and its children blocks. A basic block is a block that does not have any child block in a tree. A basic block means that the value inside it is not derived from other data; it must be collected directly or determined by decision makers directly. When the values of all the basic blocks are known, the values of other blocks in the same tree can be automatically derived.

Blocks have the following attributes:
Name of the block
   e.g., Annual profit
Description of the block
   e.g., Annual profit of Department A in an organisation.
Measurement (including values and units)
   e.g., $200 M per annum
Threshold
   e.g., $180 M per annum
Parameters (factors) that will affect the block directly
   e.g., avenue and annual cost of the department
Parameters (factors) that will be affected by the block directly
   e.g., the total profit of the organisation

A parameter in a block can affect a number of parameters from other blocks, which are termed as constrained parameters, and at the same the parameter in a block can also be affected by some parameters from the remaining blocks, which are termed as constraining parameters. The block contains the information on these two types of parameters.

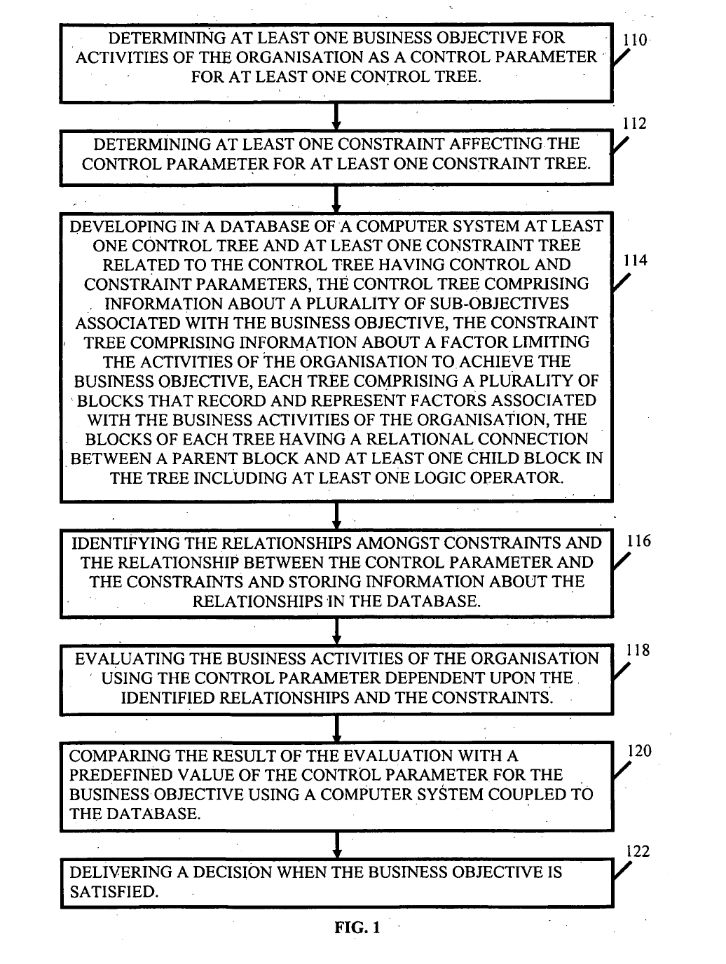

Since blocks are represented in computer systems, the blocks may also have the following attributes to identify themselves:
Colour of the block;
Location of the block in a tree (graph); and
The lines that are linked to the block.
   FIG. 1 illustrates a computer-implemented method of automated making of decisions regarding a business objective of an organisation. In step 110, at least one business objective is determined for activities of the organisation as a control parameter for at least one control tree. In step 112, at least one constraint affecting the control parameter for at least one constraint tree is determined. In step 114, in a database of a computer system, at least one control tree and at least one constraint tree related to the control tree having control and constraint parameters are developed. The control tree comprises information about sub-objectives associated with the business objective. The constraint tree comprises information about a factor limiting the activities of the organisation to achieve the business objective. Each tree comprises blocks that record and represent factors associated with the business activities of the organisation. The blocks of each tree have a relational connection between a parent block and at least one child block in the tree including at least one logic operator.

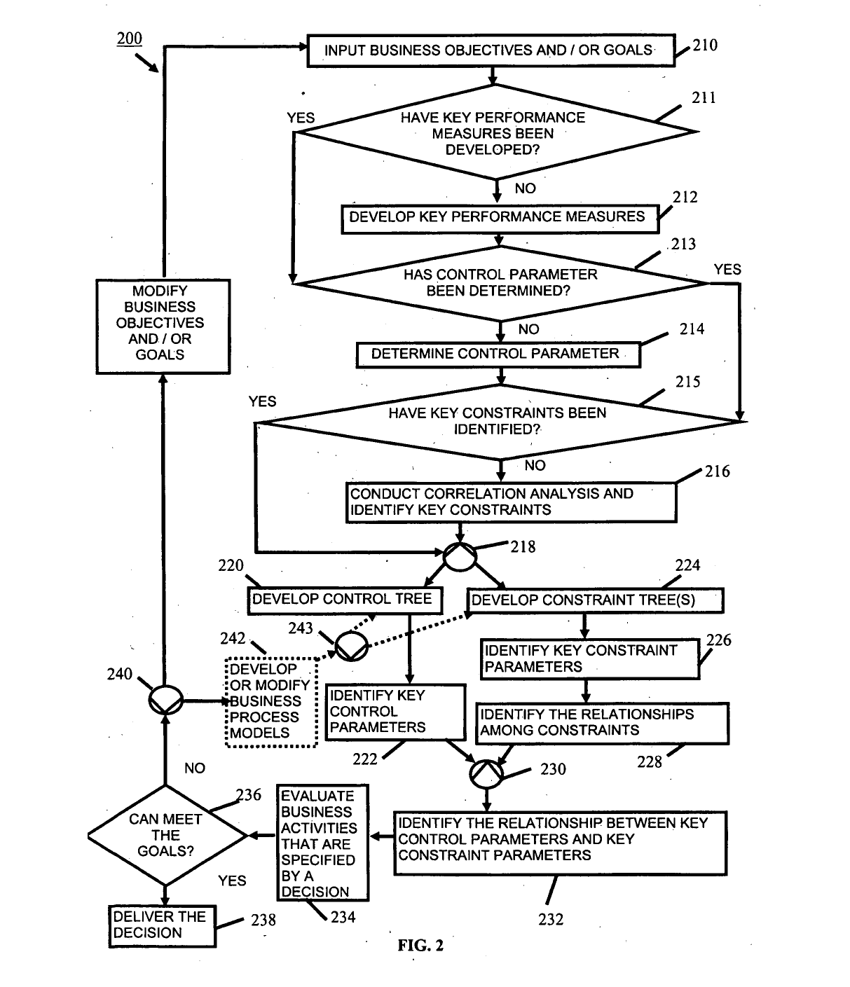

In step 116, the relationships amongst constraints and the relationship between the control parameter and the constraints are identified, and information about the relationships is stored in the database. In step 118, the business activities of the organisation are evaluated using the control parameter dependent upon the identified relationships and the constraints. In step 120, the result of the evaluation is compared with a predefined value of the control parameter for the business objective using a computer system coupled to the database. In step 122, a decision is delivered when the business objective is satisfied. These and other aspects are described in greater detail with reference to FIG. 2.

FIG. 2 illustrates in detail a method 200 for making a business decision dependent upon control and constraint trees in accordance with an embodiment of the invention. FIG. 2 shows a Control and Constraint Trees approach, which comprises a heuristic algorithm. Processing commences in step 210. In step 210, business objectives and/or goals are input. That is, overall objectives (the objectives or goals at overall business or organisational level) of an organisation and requirements to meet these objectives preliminarily are identified. The method 200 may involve cascading down the identified business objectives and requirements into business operational goals at different levels of the organization. When the methodology is used for making decisions for a specific business process, e.g., management of a specific engineering asset, the specific goals and the specific constraints of the specific business process (e.g., again managing the specific engineering asset) must be identified. The identification of business objectives/goals is usually performed by human, although the identification can be done using a computer program if objectives/goals have been stored in the database that the computer program can access.

In decision step 211, a check is made to determine if key performance measures have been developed. If step 211 returns true (YES), processing continues at step 213. Otherwise, if step 211 returns false (NO), processing continues at step 212. In step 212, key performance measures are developed. An objective/goal is usually described in an abstract manner. To make the objective/goal evaluable, the objective/goal must be measurable. Some objectives are measurable, such as increasing profit, whereas others are not, such as improving customer satisfaction. For unmeasurable objectives, measurements need to be defined, e.g., a measurement for “improving customer satisfaction” can be “decreasing number of service interruptions”.

In decision step 213, a check is made to determine if the control parameter has been determined. If step 213 returns true (YES), processing continues at step 215. Otherwise, if decision step 213 returns false (NO), processing continues at step 214. In step 214, a control parameter is determined. At least one core objective/goal is identified from the objectives/goals input (identified) in step 210. This objective/goal is chosen as a control parameter in step 214. This goal can be an overall objective(s) or a business operational goal(s), which is a sub-objective(s) derived from the overall objective(s). An overall objective is defined at the top level of an organisation for the whole business of the organisation, while a business operational goal is defined at a lower level in an organisation or for a specific activity. If there is more than one core goal, any one or more of these objectives/goals may be used as the control parameter. Any other objectives/goals become are deemed to be constraint parameters. Processing continues at step 215.

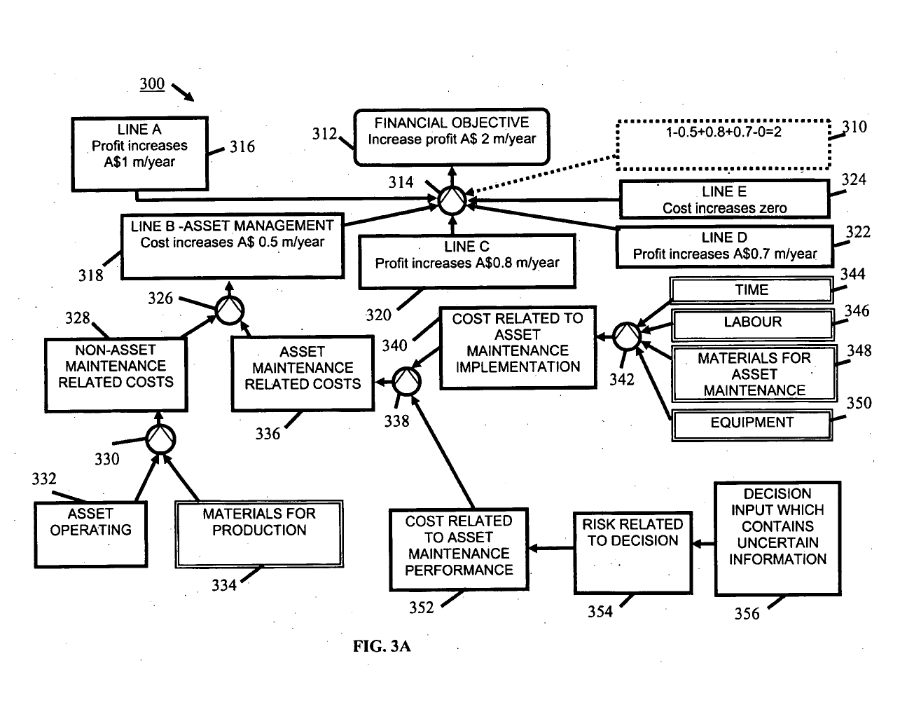

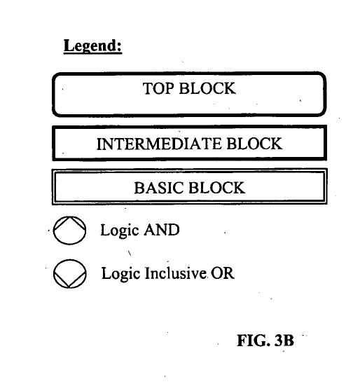

In decision step 215, a check is made to determine if key constraints have been identified. If step 215 returns true (YES), processing continues at Logic AND node 218. Otherwise, if decision step 215 returns false (NO), processing continues at step 216. In step 216, correlation analysis is conducted, and key constraints are identified. The correlation analysis is conducted on the control parameter of step 214 and each individual constraint to determine whether this constraint has an impact on the control parameter (core goal) or not. The impact is measured by the correlation coefficient, which has a value between 0 and 1. The value of zero means “no impact or influence”, whereas the value of one means “completely impacts”. A constraint is significant to a control parameter if the correlation coefficient between the constraint and the control parameter is high (normally above 0.7). However, different users can have different definitions for “high correlation coefficient”. Processing continues at Logic AND node 218 (see Legend in FIG. 3B). The logic “AND” operates on “DEVELOP CONTROL TREE” and “DEVELOP CONSTRAUNT TREE(S)”. The input is “Key constraints”, which means that once key constraints have been identified, the actions “DEVELOP CONTROL TREE” and DEVELOP CONSTRAUNT TREE(S)” are implemented simultaneously.

From node 218, processing continues along two parallel branches as depicted in FIG. 2. However, one skilled in the art will readily recognise in the light of this disclosure that alternative arrangements for processing can be made without departing from the scope and spirit of the invention (e.g., serial processing). In step 220, a control tree is developed. The top blocks, all intermediate blocks and basic blocks, as well as their relationships, are identified; and these relationships are presented in a graph. The control tree is developed based on the determined control parameter (from step 214). The start point of this control tree (Top Block—see Legend in FIG. 3B) is one of the overall objectives. In step 222, key control parameters are identified. A goal is often affected by a number of factors that are termed as control parameters. These factors can be identified by human or machines and measured by certain parameters. The “key” control parameters indicate those control parameters that make a significant contribution to achieving the core goal (i.e., the top block). From step 222, processing continues at Logic AND node 230. Steps 220 and 222 are one flow branch between Logic AND nodes 218 and 230. The other flow branch comprises steps 224, 226, and 228.

In step 224, one or more constraint trees are developed. The constraint trees are developed based on the key constraints, which have strong co-relationships with the control parameter. In step 226, the key constraint parameters are identified. A constraint is often affected by a number of factors that are termed as constraint parameters. These factors can be identified by a human or machines and measured by certain parameters. In step 228, the relationships among constraints are identified. This is done by conducting correlation analysis and/or system dynamic analysis. Processing continues from step 228 to Logical AND operator 230. The inputs are key control factors and relationships among constraints. From step 230, processing continues at step 232.

In step 232, the relationship between the key control parameters and the key constraint parameters is identified by conducting correlation analysis and/or system dynamic analysis. That is, the relationship between the control parameter and each constraint in the constraint tree(s) is identified. This relationship is presented quantitatively based on historical data, i.e., by measurements of the control and constraint factors (parameters). Once the historical data of control parameters and constraint parameter have been collected and stored in a computer system, the relationship between the control parameters and the constraint parameters can be mathematically formulated by a human or a computer. Identification of these relationships often involves reliability analysis and cost analysis, and may involve loss analysis and inventory analysis.

In step 234, the business activities that are specified by a decision are evaluated. In control and constraint trees, a number of business activities are involved These business activities are conducted to achieve the objectives/goals of an organisation. These business activities result in various outcomes such as revenue, cost and maybe environmental pollution. The business activities are evaluated by comparing the outcomes such as cost and throughput of an activity with the expected values (required values or predefined thresholds) for these outcomes. This may involve calculating the corresponding values of the control parameter based on the relationships and constraints from step 232. Further, relationships between different constraints are calculated, and then the final value of the control parameter is derived based on the values estimated in step 232 and the corresponding relationships. The term “estimated” here also includes “calculated” if algorithms or models are available for the calculation of the values. However, these values are often “estimated” by experts. In step 234, the result is the expected value of the control parameter that is delivered by existing business activities under the current constraints. For example, in a water supply company, business activity is “providing water to customers”. In this case, the control parameter can be “delivered water” and the expected value can be “the amount of water delivered in a month”. One constraint can be “the capacity of pumps that are used to deliver the water”.

In decision step 236, a check is made to determine if the business objectives and/or goals (of step 210) can be met using the business activities. This involves comparing the result of step 234 with the required value of the core objective/goal to decide whether existing business activities can meet the business objectives. The required value of an objective/goal is the measurable target of the objective/goal, e.g., assuming a goal to upgrade a production line is “to increase profit by 5%”, then the required value is 5%. If decision step 236 returns true (YES), processing continues at step 238 and the decision is delivered. In step 238, a computer system can be used to deliver the decision using a computer program that generates a message to indicate what should be done, how to do what should be done, and when to do what should be done. This message can further trigger job orders. However, if decision step 236 returns false (NO), processing continues at step 240 (again see Legend in FIG. 3B)

In step 240, a logic inclusive “OR” is performed. The logic inclusive OR represents that one or more of three actions may be taken. Thus, the logic inclusive “or” indicates processing may continue at step 241, at step 242, or at both steps 241 and 242. The availability of these options should be checked before taking an action. If the existing business activities cannot meet the business objectives/goals (step 236 returns false (NO)), three solutions can be used. The operation “OR” is an “INCLUSIVE OR”, i.e., once the outcome is “No”, either “Develop or modify business process models” or “Modify business objectives and/or goals” or both are performed. The options are normally selected by a human. Processing can continue at step 241, in which the business objectives and/or goals are modified, before processing continues at step 210, described hereinbefore. This may involve modifying current business objectives. Processing can continue from logic OR 240 to optional step 242 (indicated by broken lines), in which business process models can be developed or modified. This may be involve modifying current business processes, or negotiating existing constraints, in which an optimal solution can be obtained from the relationship between the control parameter and the corresponding constraint (indicated by broken line arrows from step 242 to a logic OR 243 and from there to steps 220 and 224). Changing a business process often results in some changes in business goals and constraints. The current way of implementing the specified business activities can be changed. The method 200 may terminate after one iteration, or may be carried out repeatedly until a decision is delivered in step 238. Still further, processing may continue from Logic OR 240 to both steps 241 and 242. If the outcome of step 236 is “No”, either step 241 or 242 or both are performed. The options are selected by a human.

If new constraints are identified or more data becomes available, the confidence level of analysis can be improved through repeating steps 220, 222, 224, 226, 228, 230, 232, 234, 236, 240, and 242. For example, constraint trees can be added based on newly identified constraints; normally, the original developed constraint trees are left unchanged. One only needs to develop new constraint trees based on newly identified constraints or improve the accuracy of corresponding relationships to formulate the relationships between the control parameters and the newly identified the constraints. In the above method 200, a single core business objective or goal is recommended as the control parameter. Other business objectives can be modelled as constraints. However, multiple objectives/goals can also be used as the control parameters in certain circumstances. In this case, multiple control trees need to be developed. Using multiple control goals affects steps 220 and 224 only. The models and methodologies for BPM, TOC and MCDM can be applied into the CCT approach. BPM can be used to develop trees, TOM can be used to identify critical constraints, and MCDM can be used to evaluate decisions.

In CCT approach, the implementation of the above proposed procedure can be flexible and some steps may be skipped. In a first iteration of the method 200 of FIG. 2, each step up to step 236 is performed. However, one or more steps may be skipped in subsequent iterations. For example, step 210 identifies the overall objective(s) of an organisation. If the overall objective(s) has (have) been identified, this step may be skipped in the subsequent iteration.

The CCT method 200 provides a systematic methodology to (1) quantitatively analyse the dynamic relationship of the business activities of an organization, its objectives and the constraints, (2) identify multiple constraints so that decision model can be formulated, as well as (3) monitor business performances at different organisation levels and their impacts on the business performance at higher levels.

Four major applications of the CCT method include:
1) Facilitate the formulation of the objective and constraint relationships for multiple criteria decision making;
2) Allocating the thresholds for different departments of an organisation and different hierarchy of business activities in the organisation as shown in steps 210, 212, 220, 224, and 232. This function can ensure that the activities at different departments can be established collaboratively in a line with the overall business objectives, and the whole business objectives become more achievable.
3) Supporting decision making as shown in steps 234, 236, and 238. The provided function enables the decision making process to be traceable by reversing the decision making process in FIG. 2, i.e., 238→236→234→232.
4) Monitoring business performance as shown in steps 210, 234, and 236. This function makes the entire business activities more controllable. Users can evaluate if a business activity can meet predefined business objectives through comparing the expected outcomes from the activity with the business objectives before starting to execute the business activity.

FIG. 3B contains a legend showing symbols for a Top Block, an Intermediate Block, and a Basic Block, as well as Logic AND and Inclusive OR operators. The contents of these blocks are different.

FIG. 3A is an example of a control tree 300, in this case for financial control. FIG. 3A shows the control tree 300 with a control parameter “financial objective” 312. An organisation is assumed to have five business stream lines, named Line A to Line E (316, 318, 320, 322, 324), in this example. The arrows from these blocks 316, 318, 320, 322, 324 (and 310) are to logic AND operator 314. In particular, Line B 318 is assumed to be asset management. The overall business objective of the organisation 312 is assumed to increase profit of A$2 million every year. This business objective 312 has been allocated to each business line 316, 318, 320, 322, 324 based on the nature of individual business line, e.g., the assumed business objective for Line B (asset management) 318 is to control cost increase under A$0.5 m/year. This objective can be further decomposed to other categories at a lower level such as non-asset management related cost 328 and asset management related cost 336.

In the top block 312, the control objective is to have a profit of two million Australian dollars (A$2 million) per year. As indicated by additional (optional—indicated by dashed line) box 310, this box 310 is used to explain the decomposition of the control objective. The profit is increased to A$2 million per year, which is achieved through the five blocks (business lines) 316, 318, 320, 322, 324, i.e., 2=1−0.5+0.8+0.7−0. The relational connection to top block 312 includes the logic AND 314 and, to the logic AND 312, from the blocks 316, 318, 320, 322, and 324.

In intermediate blocks 316, 318, 320, 322, and 324, Line A—profit increases to A$1 million per year, Line B asset management (AM)—cost increases to A$0.5 million per year, Line C—profit increases A$0.8 million per year, Line D—Profit increases A$0.7 million per year, and Line E—cost increases A$0 (zero Australian dollars), respectively. FIG. 3A shows assumed business streamlines (aspects or departments) in the organisation. The relational connection to event 318 includes a logic AND operator 326, which combines a block 328 for non-asset maintenance related costs and a block 336 for asset maintenance related costs. In turn to the block 328, the relational connection includes logic AND 330, which combines asset operating block 332 and a basic block 334 of materials for production. The asset operating block 332 is an intermediate block, because the block 332 can further be divided into energy consumption cost and operator cost. In relation to block 334, material cost is a basic cost.

To the block 336, the relational connection includes logic AND 338, which in turn combines a block 340 for cost related to asset maintenance implementation and a block 352 for cost related to asset maintenance performance. To the block 340, the relational connection includes logic AND 342, which combines basic blocks for time 344, labour 346, materials for asset management 348, and equipment 350, respectively. To the logic AND 338, the relational connection is to cost related to asset maintenance performance block 352. A block 356 for decision input which contains uncertain information is coupled to risk-related-to-decision block 354 (risk which is related to decisions, because the decisions may be wrong). The block 354 is input to the block 352.

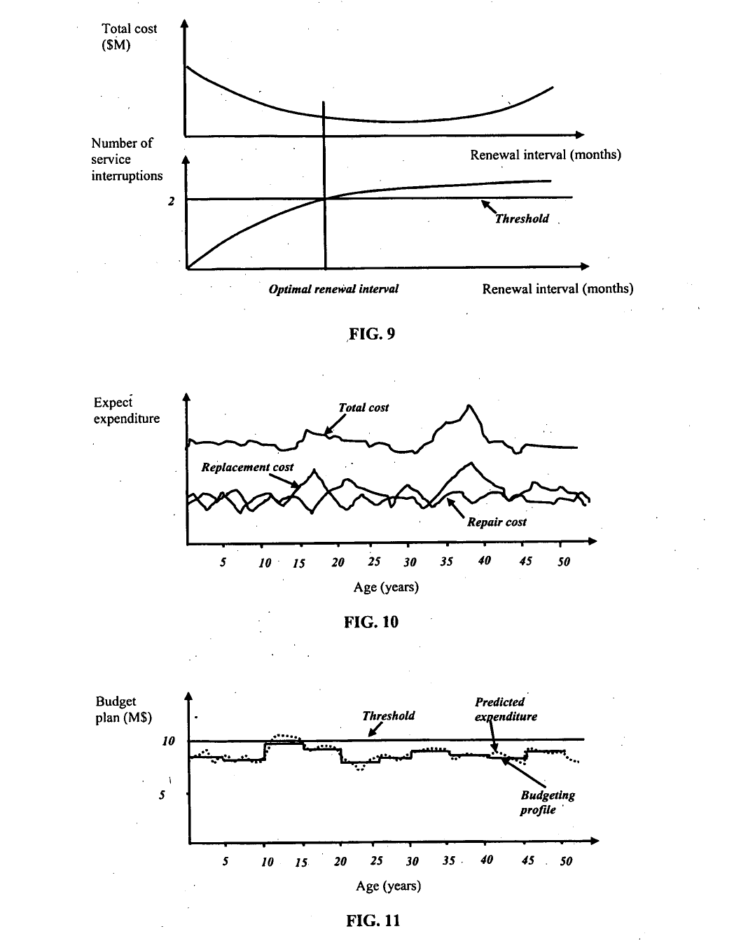

FIG. 3A demonstrates a control parameter (tree) 300 and FIG. 4 demonstrates a constraint parameter (tree) 400. The linkage of these two parameters is demonstrated in FIG. 10. In general, reducing asset-maintenance-related cost can increase profit, but causes degradation of service level.

FIG. 4 illustrates an example of a constraint tree 400. The top block is service level 410. To the block 410, the relational connection includes logic AND operator 412 combining Line A, Line B—Asset Management (AM), Line C, Line D, and Line E blocks 414, 416, 418, 420, and 422. To Line B (AM) block 416, the relational connection includes logic AND operator 424 combining a basic block for asset availability 426 and a intermediate block for asset capacity 428 which has an associated value of 23. The relational connection to intermediate block 428 includes logic AND operator 438. The logic AND operator 438 combines basic blocks 430, 432, 434, 436, and 440 which have associated values of 10, 5, 8, 0 (zero) and 0 (zero), respectively as shown in FIG. 4. The basic block 430 is for constraints from Line A; the capacity required by Line A is 10 units. The basic block 432 is for constraints from Line C; the capacity required by Line C is 5 units. The basic block 434 is for constraints from Line D; the capacity required by Line D is 8 units. The basic block 436 is for constraints from Line E; the capacity required by Line E is 0 unit. The basic block 440 is for constraints from Line B itself; the capacity required by Line B only is 0 unit.

From logic AND 438, the logic connection is to intermediate block 428 for final or total constraints on capacity, which should be provided by Line B (10+5+8+0+0=23).

FIG. 4 demonstrates a constraint tree with a constraint parameter “service level” and all factors that affect this parameter directly. As in FIG. 3A, an organisation is assumed to have five business streamlines with Line B 416 being assumed to be asset management. Different business lines have different service requirements which form an overall requirement on business service level. These service requirements become constraints when reducing business costs (to increase profit). As an example, the service requirements for Line B (asset management) 416 are assumed to be measured by asset availability 426 and asset capacity 428. Different business lines have different requirements for capacity. Aggregating all these requirements forms an overall requirement on capacity. Units in FIG. 4 could be anything that is used to measure the capacity of a particular asset. For example, if the particular asset is a pump to supply water, the unit usually is “ML/Hour”.

An example of an implementation example of the CCT system is set forth hereinafter. The CCT system defines and formulates decision problems (e.g., asset renewal problems). The CCT system can formulate optimal asset renewal decision support. Asset owners often need to decide whether to renew or replace an asset that have critical value to a business.

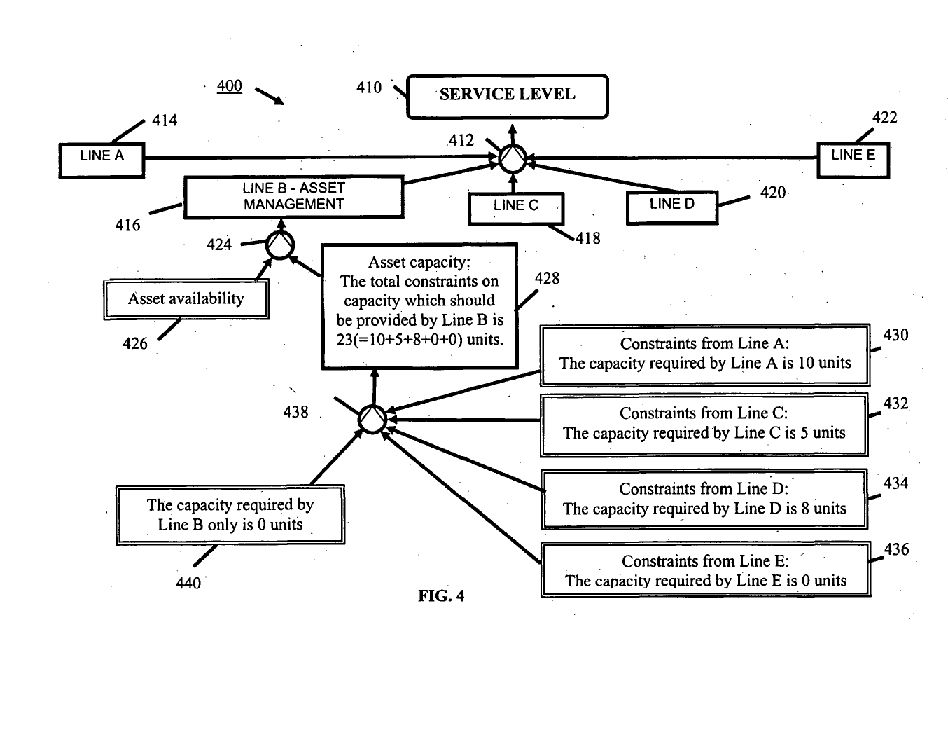

An organisation's business can be defined by multiple objectives in different dimensions, as shown in FIG. 5 illustrating an example of a water supply organisation 500. Under the heading Business Objectives 510, a number of categories are specified, including business management 520, organisation 530, customers 540, finance 550, external relationship(s) 560, and assets 570. Under business management 520, the objectives/goals are: improve corporate governance efficiency 522 and grow business 524. Under the organisation objective 530, the objectives are: improve organisation structure 532 and maintain workforce effectiveness and efficiency 534. Under customers 540, the objectives are: improve customer satisfaction 542 and obtain required customers 544. Under finance 550, the objectives/goals are: improve profitability 552 and ensure financial sustainability 554. Under external relationship 560, the objectives/goals are: improve community satisfaction 562, maintain good relationship with government and media 564, and address environmental issues 566. Under assets 570, the objectives/goals are: ensure asset serviceability 572 and ensure asset safety 574.

A capital asset renewal decision must align with the overall business objectives of an organisation and consider all critical constraints that limit the organisation's ability to achieve these objectives. The CCT system is an effective tool to address this issue and to assist organisations to make optimal decisions. The procedures of the renewal decision making using CCT are described hereinafter. Business objectives and their hierarchal structure may be input manually into a database of a computer system. FIG. 5 shows a demonstrative business objective hierarchy diagram. Core goal(s) are identified relevant to the asset renewal decision from business objectives and Control Tree(s) are developed. The core goals are defined as control parameters. A number of Control Trees can be developed for each individual control parameter.

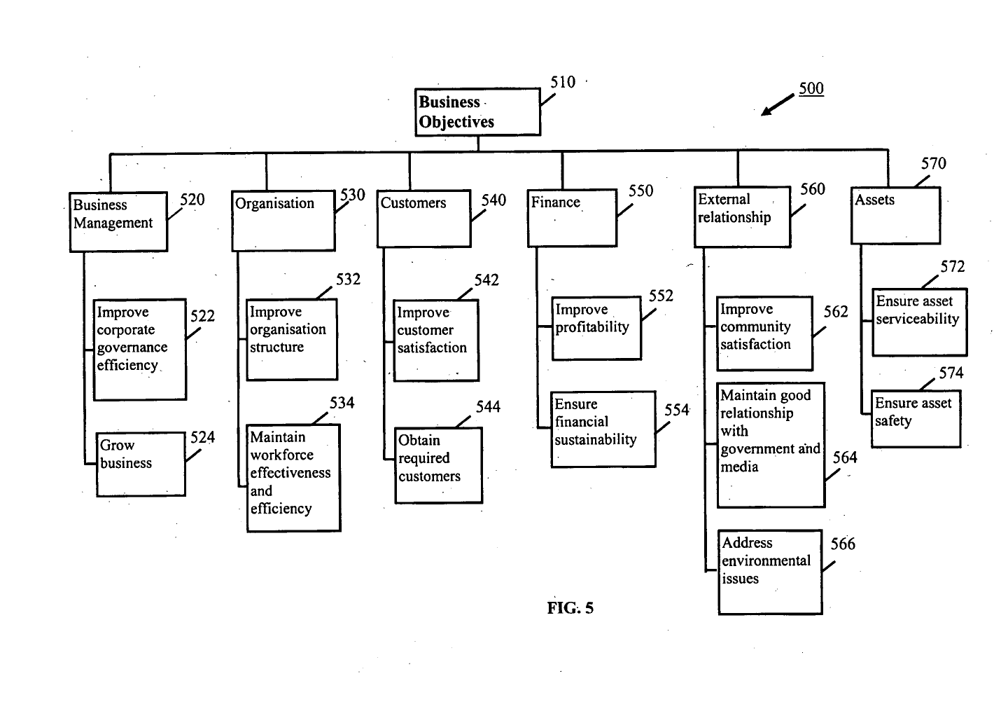

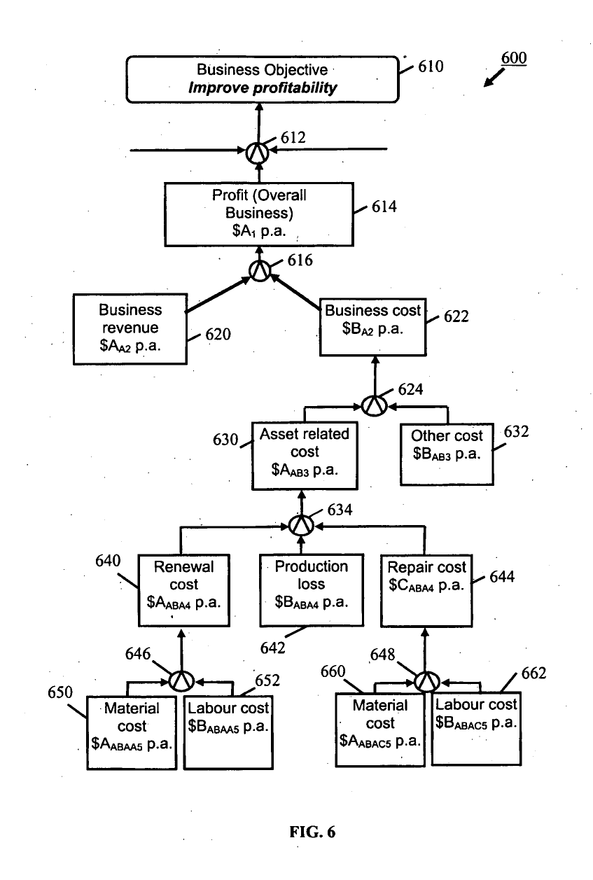

In the example shown in FIG. 5, the business objective “Improve profitability” 552 is assumed as a core goal 600 in FIG. 6. Top block 610 is a business objective to improve profitability (552 in FIG. 5). This has a relational connection including logic AND operator 612 with a block 614 of profit (Overall Business)—dollar per annum ($A₁ p.a.). The horizontal lines into the logic AND operator 612 indicate other possible branches (i.e., other business objectives), which have been truncated. The relational connection to block 614 includes a logic AND operator 616 combining a block 620 for business revenue ($A_{A2} p.a.) and a block 622 for business cost ($B_{A2} p.a.). The relational connection to the block 622 includes a logic AND operator 624 combining a block 630 for asset-related cost ($A_{AB3} p.a.) and a block 622 for other cost ($B_{AB3} p.a.).

The relational connection to the block 630 includes a logic AND operator 634 combining a block 640 for renewal cost ($A_{ABA4} p.a.), a block 642 for production loss ($B_{ABA4} p.a.), and block 622 for repair cost ($C_{ABA4} p.a.). The relational connection to the block 640 includes a logic AND operator 646 combining a block 650 for material cost ($A_{ABAA5} p.a.) and a block 652 for labour cost ($B_{ABAA5} p.a.). The relational connection to the block 644 includes a logic AND operator 648 to combine a block 660 for material cost ($A_{ABACS} p.a.) and a block 662 for labour cost ($B_{ABAC5} p.a.).

Referring again to FIG. 5, the other objectives in FIG. 5 may become constraints, since these objectives also need to be achieved. The computer system can define these related business objectives as constraints by default. The development of the Control Tree starts from the identified core goal and then drills down to lower levels until the basic blocks. A basic block means that its value is not derived from other data, but is determined by decision makers directly or collected from the field directly. When a number of child blocks at a lower level are derived from a block, the logic and numerical relationships between this block and the child blocks at the lower level should be defined and input into the database.

At this step, the objective of optimisation needs to be identified, which in the example of FIG. 6 is “Improve profitability”. Though the core goal is to improve profitability, a defined practical target range (or threshold) is often needed. For example, the target may be to achieve 20% increase in profit, with the lower limit being 5%. The threshold of the core goal may be input into the database manually. If n blocks are derived from a parent block, the thresholds of n−1 blocks may be input manually. The threshold of the last block may be determined automatically by the computer system based on the relationship between these n blocks and their parent block.

With reference to FIG. 6, the following represent thresholds for corresponding goals:
$Aᵢ where i={1, A2, AB3, ABA4, ABAA5, ABAC5} p.a.,
$Bⱼ where j={A2, AB3, ABA4, ABAA5, ABAC5} p.a., and
$C_{ABA4} p.a.

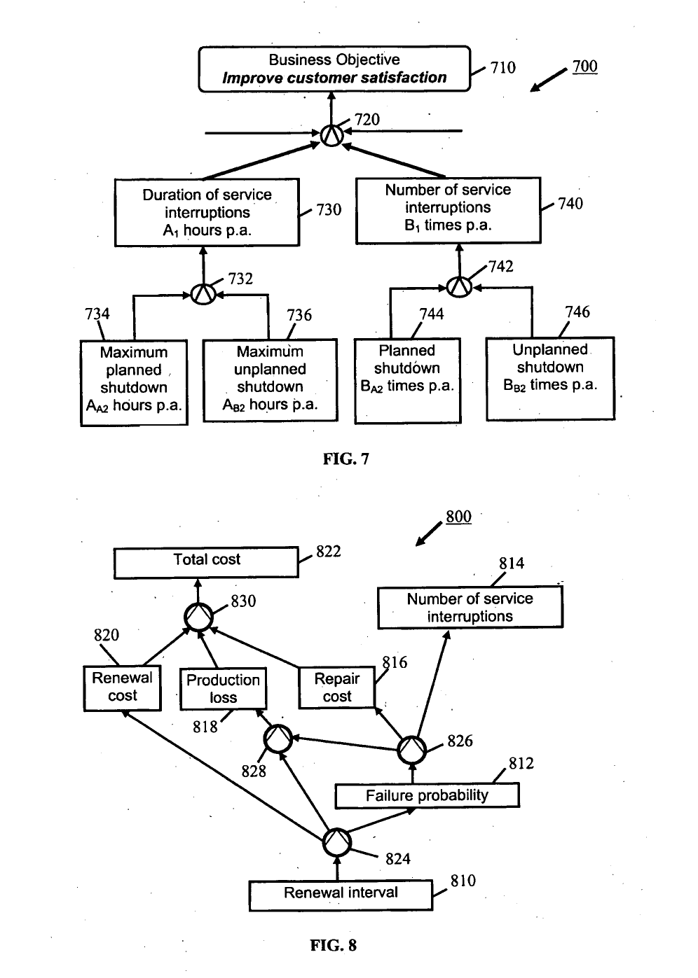

Next, Constraint Trees are developed and critical constraints that limit the organisation's ability to achieve the optimal target of the core goal, are identified. In this example, the critical constraint is assumed to be improve customer satisfaction 542 of FIG. 5 (700 in FIG. 7).

In FIG. 7, the top block is “improve customer satisfaction” 710. The relational connection to the block 710 includes a logic AND operator 720 combining a block 730 for the duration of service interruptions (A₁ hours p.a.) and a block 740 for the number of service interruptions (B₁ times p.a.). The horizontal lines into the logic AND operator 720 indicate other possible branches, which have been truncated. The relational connection to a block 730 includes a logic AND operator 732 combining a block 734 for maximum planned shutdown (A_{A2} hours p.a.) and a block 736 for maximum unplanned shutdown (A_{B2} hours p.a.). The relational connection to the block 740 includes a logic AND operator 742 combining a block 744 for planned shutdown (B_{A2} times p.a.) and a block 746 for unplanned shutdown (B_{B2} times p.a.). In FIG. 7, Ai (i={1, A2, B2}) hours p.a. and Bi (i={1, A2, B2}) times p.a. represent thresholds for corresponding constraints.

The linkage between the control parameter and the constraints at different levels is then built. These linkages are automatically built, because all child and grandchild blocks of a control parameter or constraint, i.e., sub-goals and sub-constraints are developed in a tree structure that has been defined and the linkages between the control parameter and the constraints at the top level have been developed. Users need to select parameters (the control parameters and/or constraints) that are critical for their decisions. The linkage between the control parameter (the core goal) and constraints at the top level can be automatically generated by the computer system due to predefined business objective tree (see FIG. 5). However, controlling the core goal and the constraints through controlling their children and grandchildren (sub-goals and sub-constraints) at lower levels is often more achievable than controlling the core goal and the constraints at the top level directly. For example, reducing the number and the duration of planned and unplanned shutdowns is more achievable than improving customer satisfaction directly. To control the sub-goals and sub-constraints accurately, the linkages between sub-goals and sub-constraints at controllable levels need to be identified.

In the example shown in FIGS. 5, 6 and 7, an organisation is assumed to need to decide an optimal renewal interval for a group of assets as to maximise the profit of the organisation. To make this decision, the linkage between the control parameter “Total Cost (i.e., asset related cost)” 630 in FIG. 6 and the constraint parameter “number of service interruptions” (see block 740 in FIG. 7) is built through a decision parameter “renewal interval”, because renewal interval of these assets affects the total cost and the service interruptions simultaneously. FIG. 8 is built to link a block in the control tree and a block in a constraint tree; the figure shows neither a control tree nor a constraint tree. FIG. 8 is a relationship chart developed using dynamic systems thinking drawn from top-bottom. The purpose for using a different way is to distinguish the relationship chart from other tree diagrams. A block 810 represents a decision parameter. The relational connection from the renewal interval block 810 is to a logic AND operator 824, which in turn connects with a renewal cost block 820, a logic AND operator 828, and a failure probability block 812. The failure probability block has a relational connection to a logic AND operator 826. The logic AND operator 826 is connected to the logic AND operator 826, a repair cost block 816 and a number of service interruptions block 814. The logical AND operator 826 is connected to a production loss block 818. The renewal cost block 820, the production loss block 818, and the repair cost block 816 are connected to a logic AND operator 830. The relational connection from blocks 816, 818, and 820 is to the block 822 for total cost.

The quantitative relationship between each of the selected controllable parameters (i.e., sub-goals or sub-constraints) and their top parent parameter (i.e., the core goal or one of the critical constraints) must be built, as well as building the relationship between the control parameter and the constraint parameter. These relationships can be represented using functions or graphs. The relationships are input and stored in a database so that the computer system can retrieve the relationships and calculate the value of any one of these parameters when the values of other parameters are given. The calculation values are automatically updated when the values of other parameters are updated, either manually or through monitoring and control systems. The computer system can also present the relationships graphically.

To assist in decisions, the quantitative relationships mentioned in the above are often described through the decision parameters. As shown in FIG. 9, the relationship between the control parameter “total cost” 822 and the constraint parameter “number of service interruptions” 814 of FIG. 8 is developed through the decision parameter “renewal interval” 810 of FIG. 8. FIG. 9 illustrates two aligned plots, one for number of service interruptions and the other for total cost (e.g., $M=million dollars) both being functions of renewal intervals (in months). A threshold of two (2) is specified for the number of service interruptions in this example. At the intersection of the curve for the number of service interruptions, the optimal renewal interval is found, which has a corresponding total cost point in the curve for total cost. The cost point is a relatively low point in the plotted interval.

Next, an optimal renewal decision is made. In this step, the computer system can automatically calculate the global optimal renewal interval based on the relationship between the control parameter (e.g., the total cost) and the decision parameter (e.g., the renewal interval), as well as the relationship between the constraint parameter (e.g., the number of service interruption) and the decision parameter (e.g., the renewal interval) as shown in FIG. 9. These relationships that may be described by a formula are identified and stored in the database in advance, as described hereinbefore. The decision makers can also modify the recommended renewal interval based on other factors that have not been analysed using CCT, such as the availability of human resource.

The maintenance expenditure can then be calculated. Using a build-in algorithm, maintenance cost history and predicted failure distribution that has been recorded in the database, the computer system can automatically calculate the maintenance expenditure of a given group of assets after the renewal decisions of these assets have been determined. To do so, the replacement cost and repair cost of an asset in the group are calculated separately. The two costs are summed to obtain the maintenance expenditure for each individual asset in the group. The algorithm is a computer program that is used to predict failures of an asset and the corresponding costs including repair cost, replacement cost and production loss.

FIG. 10 illustrates the expected repair, replacement, and total costs of each individual asset are predicted as described hereinbefore. The plot in FIG. 10 shows expected expenditure as a function of age (in years)

The maintenance budget for the given group of assets can be planned. Using a built-in algorithm, the computer system can automatically calculate the whole expected expenditure for the specified assets based on their individual expected expenditure. A budget plan over a given period can be made based on the whole expected expenditure and a given budgeting interval. In FIG. 11, five 5-year budget (millions of dollars—M$) is planned over a period of 50 years. A budget threshold of $10 million is specified (indicated by a solid horizontal line). A curve of predicted expenditure is shown using a dotted line in FIG. 11. Also plotted is the budgeting profile indicated by a solid line. In a five year period, the budgeting profile is constant. The planned budget is compared with the budget threshold, which has been set, and stored in the database as described hereinbefore. If the budget exceeds the threshold, trigger an alarm to remind the decision makers to reconsider the decisions. In this example, the threshold is assumed to be $10 M. The maximum budget has not exceeded the limit. The predicted expenditure during this period may exceed the predefined budget limit. The budget, however, will not exceed the limit as shown in FIG. 11. Therefore, the budget is accepted.

The performance of engineering asset management can be evaluated. The data on the critical factors related to the basic blocks (basic control parameters and constraint parameters) are collected and input into the computer system. The system then compares the data values with the thresholds, which have been predefined and stored in the database when developing the Control Trees and Constraint Trees. The result of this comparison indicates that the current asset management performance is acceptable, unacceptable, or should be alerted at all levels of the organisation. A department or an office is normally associated with a block in the trees, and the top blocks are usually located in the boardroom so that the board committee can monitor the impacts of the performance of asset management on the overall business. The departments or offices at different levels can also monitor the impacts.

In the example, the failure probability is updated with more new failure data being collected. The threshold for the constraint “the number of service interruptions” is assumed to less than 2 per 12 months for the selected assets (see FIG. 9). When the actual number of service interruptions exceeds this limit, the system triggers an alarm, and the maintenance strategy of the assets needs to be reconsidered. However, if the total number of service interruptions at the local office is under the limit which is different from the limit for the selected assets, no action needs to be taken at the local office.

As described hereinbefore, the CCT technology Can be implemented using a computer system. For example, the concept of a “factor” related to business activities can be abstracted as an event block with a geometrical shape, a Name and a Value in a CCT graph. Logical relationships between multiple business “factors” can be expressed as directed connections and mathematical relationship operators.

A three-tier software system could be implemented as follows:
1) Presentation layer
   This allows the user to access a collection of user commands, which embody the construction and building processes of a CCT graph, through a menu and toolbox interface. Operators for aggregation and calculation are integrated with the main menu of the application, along with standard open, close, save and exit commands. The client Work area may be divided into four parts:
      1. A “File Solution” that allows navigation from one constraint/control tree to another.
      2. An “Error Path” display panel, which is used to highlight problematic elements within the designed paths.
      3. A “Goal/Control/Constraint Tree” plotting Canvas, which is used to create, edit and display the control and constraint trees.
      4. A “Graphics Element” toolbox, which contains the entire available element collection. This toolbox normally is on the right hand side of the GUI and is used to allow the user to drag and drop selected event blocks and relationship operators.
2) Business layer
   This layer is a mixture of a Graph library and a Control library, which are the elementary components assisting the procedures of calculation and logic derivation. The Graph library is a logical collection of basic graph elements such as event blocks and operators. The business layer provides lifecycle management for all its components, from the first appearance on the diagram with names and value, design retrieval arid deletion. This layer is self-describing and defines its own display features. The Control library is a reusable collection of components inherited from the Graph library and a set of user defined controls. This collection carries out the partial logic functionality, serving as a courier for data message transfer and contains the relationship sets (i.e. Constraining and constrained), through the defined operations. The user defined controls provide the logical interaction with the users operations, such as setting and modifying tree elements at different levels.
3) Data layer
   An abstracted data layer, which allows the storage and retrieval of these CCT graphs based on the computer architecture. This allows this system to be installed and run on different computers. To accommodate the different applications of CCT, the defined interface is this abstract data layer that provides an alternative opportunity for a customized implementation.
      For system extensibility, interfaces between layers should be well defined and structured to ensure flexibility for further improvement.

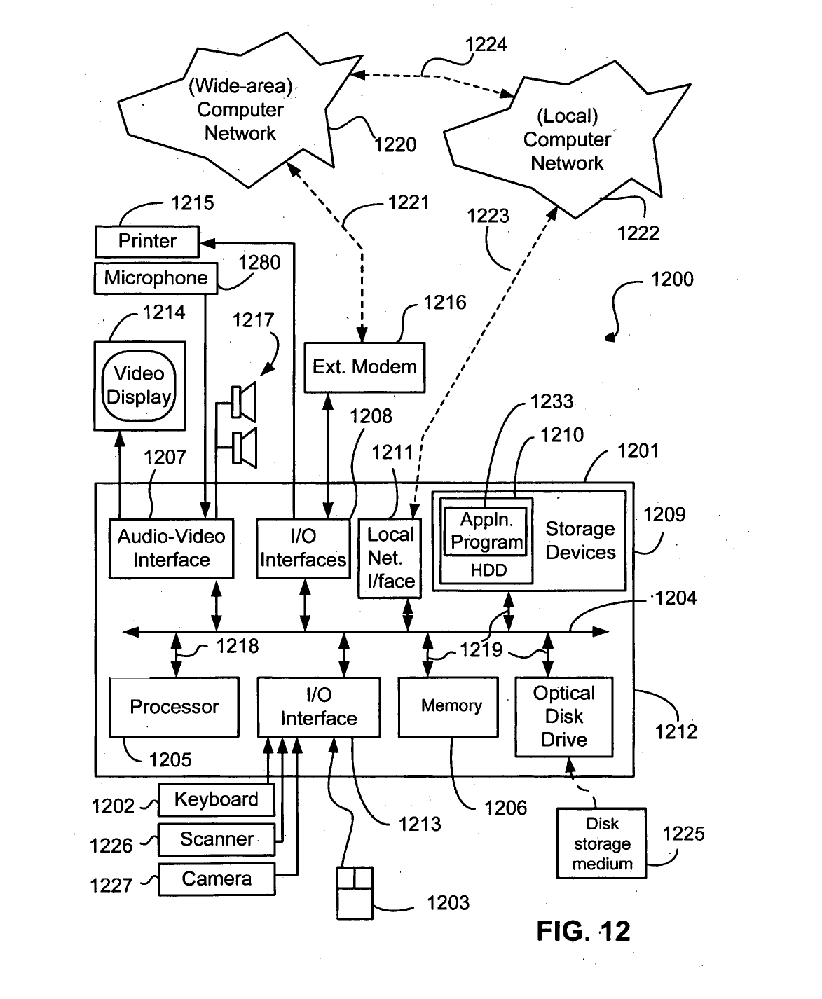

FIG. 12 is a schematic block diagram of a general-purpose computer system 1200, upon which the various embodiments of the invention can be practiced.

As seen in FIG. 12, the computer system 1200 is formed by a computer module 1201, input devices such as a keyboard 1202, a mouse pointer device 1203, a scanner 1226, a camera 1227, and a microphone 1280, and output devices including a printer 1215, a display device 1214 and loudspeakers 1217. An external Modulator-Demodulator (Modem) transceiver device 1216 may be used by the computer module 1201 for communicating to and from a communications network 1220 via a connection 1221. The network 1220 may be a wide-area network (WAN), such as the Internet or a private WAN. Where the connection 1221 is a telephone line, the modem 1216 may be a traditional “dial-up” modem. Alternatively, where the connection 1221 is a high capacity (e.g., cable) connection, the modem 1216 may be a broadband modem. A wireless modern may also be used for wireless connection to the network 1220.

The computer module 1201 typically includes at least one processor unit 1205, and a memory unit 1206 for example formed from semiconductor random access memory (RAM) and semiconductor read only memory (ROM). The module 1201 also includes an number of input/output (I/O) interfaces including an audio-video interface 1207 that couples to the video display 1214, loudspeakers 1217 and microphone 1280, an I/O interface 1213 for the keyboard 1202, mouse 1203, scanner 1226, camera 1227 and optionally a joystick (not illustrated), and an interface 1208 for the external modem 1216 and printer 1215. In some implementations, the modem 1216 may be incorporated within the computer module 1201, for example within the interface 1208. The computer module 1201 also has a local network interface 1211 which, via a connection 1223, permits coupling of the computer system 1200 to a local computer network 1222, known as a Local Area Network (LAN). As also illustrated, the local network 1222 may also couple to the wide network 1220 via a connection 1224, which would typically include a so-called “firewall” device or device of similar functionality. The interface 1211 may be formed by an Ethernet™ circuit card, a Bluetooth™ wireless arrangement or an IEEE 802.11 wireless arrangement.

The interfaces 1208 and 1213 may afford either or both of serial and parallel connectivity, the former typically being implemented according to the Universal Serial Bus (USB) standards and having corresponding USB connectors (not illustrated). Storage devices 1209 are provided and typically include a hard disk drive (HDD) 1210. Other storage devices such as a floppy disk drive and a magnetic tape drive (not illustrated) may also be used. An optical disk drive 1212 is typically provided to act as a non-volatile source of data. Portable memory devices, such optical disks (eg: CD-ROM, DVD), USB-RAM, and floppy disks for example may then be used as appropriate sources of data to the system 1200.

The components 1205 to 1213 of the computer module 1201 typically communicate via an interconnected bus 1204 and in a manner which results in a conventional mode of operation of the computer system 1200 known to those in the relevant art. Examples of computers on which the described arrangements can be practised include IBM-PC's and compatibles, Sun Sparcstations, Apple Mac™ or a like computer systems evolved therefrom.

The method may be implemented using the computer system 1200 wherein the processes of FIGS. 1 and 2 may be implemented as one or more software application programs 1233 executable within the computer system 1200. In particular, the steps are effected by instructions 1231 in the software 1233 that are carried out within the computer system 1200. The software instructions 1231 may be formed as one or more code modules, each for performing one or more particular tasks. The software may also be divided into two separate parts, in which a first part and the corresponding code modules performs the methods of automated making of decisions regarding a business objective of an organisation, and a second part and the corresponding code modules manage a user interface between the first part and the user.

The software 1233 is generally loaded into the computer system 1200 from a computer readable medium, and is then typically stored in the HDD 1210, as illustrated in FIG. 12, or the memory 1206, after which the software 1233 can be executed by the computer system 1200. In some instances, the application programs 1233 may be supplied to the user encoded on one or more CD-ROM 1225 and read via the corresponding drive 1212 prior to storage in the memory 1210 or 1206. Alternatively the software 1233 may be read by the computer system 1200 from the networks 1220 or 1222 or loaded into the computer system 1200 from other computer readable media. Computer readable storage media refers to any storage medium that participates in providing instructions and/or data to the computer system 1200 for execution and/or processing. Examples of such storage media include floppy disks magnetic tape, CD-ROM, a hard disk drive, a ROM or integrated circuit, USB memory, a magneto-optical disk, or a computer readable card such as a PCMCIA card and the like, whether or not such devices are internal or external of the computer module 1201. Examples of computer readable transmission media that may also participate in the provision of software, application programs, instructions and/or data to the computer module 1201 include radio or infra-red transmission channels as well as a network connection to another computer or networked device, and the Internet or Intranets including e-mail transmissions and information recorded on Websites and the like.

The second part of the application programs 1233 and the corresponding code modules mentioned above may be executed to implement one or more graphical user interfaces (GUIs) to be rendered or otherwise represented upon the display 1214. Through manipulation of typically the keyboard 1202 and the mouse 1203, a user of the computer system 1200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1217 and user voice commands input via the microphone 1280.

In general, the processor 1.205 is given a set of instructions which are executed therein. The processor 1205 then waits for a subsequent input, to which it reacts to by executing another set of instructions. Each input may be provided from one or more of a number of sources, including data generated by one or more of the input devices 1202, 1203, data received from an external source across one of the networks 1220, 1222, data retrieved from one of the storage devices 1206, 1209 or data retrieved from a storage medium 1225 inserted into the corresponding reader 1212. The execution of a set of the instructions may in some cases result in output of data. Execution may also involve storing data or variables to the memory 1234.

In accordance with the foregoing, a computer program product comprises a computer readable storage medium having a computer program recorded thereon. The computer program is executable by a computer apparatus to make the computer perform the computer-implemented method of automated making of decisions regarding a business objective of an organisation. The computer program comprises computer program code modules to implement the steps.

Methods, apparatuses, and computer program products for automated making of decisions regarding a business objective of an organisation have been disclosed. The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A computer-implemented method of making of decisions regarding activities of an organisation, said method comprising the steps of:
determining at least one business objective for activities of said organisation as a control parameter for at least one control tree;
determining at least one constraint affecting said control parameter for at least one constraint tree;
developing in a database of a computer system at least one control tree and at least one constraint tree related to said control tree having control and constraint parameters, said control tree comprising information about a plurality of sub-objectives associated with said business objective, said constraint tree comprising information about a factor limiting the activities of said organisation to achieve said business objective, each tree comprising a plurality of blocks that record and represent factors associated with the business activities of said organisation, said blocks of each tree having a relational connection between a parent block and at least one child block in said tree including at least one logic operator;
identifying the relationships amongst constraints and the relationship between said control parameter and said constraints and storing information about the relationships in said database;
evaluating said business activities of said organisation using said control parameter dependent upon said identified relationships and said constraints;
comparing the result of said evaluation with a predefined value of said control parameter for said business objective using a computer system coupled to said database; and
delivering a decision when said business objective is satisfied.

2. The method as claimed in claim 1, wherein said evaluating step is implemented using a computer system.

3. The method as claimed in claim 2, wherein said relationships are identified using a relationship diagram stored in a database associated with a control tree, a constraint tree, or both.

4. The method as claimed in claim 3, wherein each block in a control tree, a constraint tree, or both, contains a parameter that represents said block, the parameters that constrain the parameter shown in the block and the parameters that are constrained by the parameter.

5. The method as claimed in claim 1, further comprising the step of developing key performance measures for said at least one business objective for activities of said organisation.

6. The method as claimed in claim 1, further comprising the step of checking if key constraints have been identified.

7. The method as claimed in claim 6, further comprising the step of conducting correlation analysis and identifying key constraints if the step of checking indicates key constraints have not been identified.

8. The method as claimed in claim 1, further comprising the step of developing or modifying a business process model if the comparison result indicates that the evaluation of the business activities cannot meet said business objective.

9. The method as claimed in claim 8, where said developed or modified business process model affects development of a control tree, development of a constraint tree, or both.

10. The method as claimed in claim 1, further comprising the step of modifying said business objective.

11. The method as claimed in claim 1, wherein each tree comprises a plurality of blocks, said blocks comprising a top block, an intermediate block, and a basic block.

12. The method as claimed in claim 11, further comprising a logic AND operator, a logic Inclusive OR operator, or both.

13. An apparatus for making of decisions regarding a business objective of an organisation, said apparatus comprising:
means for determining at least one business objective for activities of said organisation as a control parameter for at least one control tree;
means for determining at least one constraint affecting said control parameter for at least one constraint tree;
means for developing in a database of a computer system at least one control tree and at least one constraint tree related to said control tree having control and constraint parameters, said control tree comprising information about a plurality of sub-objectives associated with said business objective, said constraint tree comprising information about a factor limiting the activities of said organisation to achieve said business objective, each tree comprising a plurality of blocks that record and represent factors associated with the business activities of said organisation, said blocks of each tree having a relational connection between a parent block and at least one child block in said tree including at least one logic operator;
means for identifying the relationships amongst constraints and the relationship between said control parameter and said constraints and storing information about the relationships in said database;
means for evaluating said business activities of said organisation using said control parameter dependent upon said identified relationships and said constraints;
means for comparing the result of said evaluation with a predefined value of said control parameter for said business objective using a computer system coupled to said database; and
means for delivering a decision when said business objective is satisfied.

14. An apparatus for making of decisions regarding a business objective of an organisation, said apparatus comprising:
a storage device storing a database;
a memory for storing data, a portion of said database obtained from said storage device, and a computer program; and
a processing unit coupled to said memory for executing said computer program, said computer program comprising:
computer program code means for determining at least one business objective for activities of said organisation as a control parameter for at least one control tree;
computer program code means for determining at least one constraint affecting said control parameter for at least one constraint tree;
computer program code means for developing in said database at least one control tree and at least one constraint tree related to said control tree having control and constraint parameters, said control tree comprising information about a plurality of sub-objectives associated with said business objective, said constraint tree comprising information about a factor limiting the activities of said organisation to achieve said business objective, each tree comprising a plurality of blocks that record and represent factors associated with the business activities of said organisation, said blocks of each tree having a relational connection between a parent block and at least one child block in said tree including at least one logic operator;
computer program code means for identifying the relationships amongst constraints and the relationship between said control parameter and said constraints and storing information about the relationships in said database;
computer program code means for evaluating said business activities of said organisation using said control parameter dependent upon said identified relationships and said constraints;
computer program code means for comparing the result of said evaluation with a predefined value of said control parameter for said business objective; and
computer program code means for delivering a decision when said business objective is satisfied.

15. A computer program product comprising a computer readable medium have recorded thereon a computer program for making of decisions regarding a business objective of an organisation for execution on a processing unit, said computer program comprising:
computer program code means for determining at least one business objective for activities of said organisation as a control parameter for at least one control tree;
computer program code means for determining at least one constraint affecting said control parameter for at least one constraint tree;
computer program code means for developing in said database at least one control tree and at least one constraint tree related to said control tree having control and constraint parameters, said control tree comprising information about a plurality of sub-objectives associated with said business objective, said constraint tree comprising information about a factor limiting the activities of said organisation to achieve said business objective, each tree comprising a plurality of blocks that record and represent factors associated with the business activities of said organisation, said blocks of each tree having a relational connection between a parent block and at least one child block in said tree including at least one logic operator;
computer program code means for identifying the relationships amongst constraints and the relationship between said control parameter and said constraints and storing information about the relationships in said database;
computer program code means for evaluating said business activities of said organisation using said control parameter dependent upon said identified relationships and said constraints;
computer program code means for comparing the result of said evaluation with a predefined value of said control parameter for said business objective; and
computer program code means for delivering a decision when said business objective is satisfied.
